(19) United States
(12) Patent Application Publication
(10) Pub. No.: US 2009/0119593 A1
(43) Pub. Date: May 7, 2009

(54) VIRTUAL TABLE

(75) Inventor: Zachariah Hallock, Hillsborough, NC (US)

Correspondence Address: Weaver Austin Villeneuve & Sampson LLP, P.O. BOX 70250, OAKLAND, CA, 94612-0250, US

(73) Assignee: CISCO TECHNOLOGY, INC., San Jose, CA (US)

(21) Appl. No.: 11/934,041

(22) Filed: Nov. 1, 2007

(51) Int. Cl. G06F 3/048

(52) U.S. Cl. 715/719

(57) ABSTRACT

In one embodiment, an apparatus having a processor configured to: receive a first video image captured by a first camera via a first polarized filter having a first polarization, the first video image pertaining to a first display at a first location; receive a second video image from a first logic device, the second video image captured by a second camera via a second polarized filter having a second polarization, the second video image pertaining to a second display at a second location; transmit the second video image to the first display; control the first display to display the second video image, the first display having a third polarization substantially opposite from the first polarization; and transmit the first video image to the first logic device, the first video image to be displayed onto the second display having a fourth polarization substantially opposite from the second polarization.

### BACKGROUND

1. Technical Field

The present disclosure relates generally to real-time virtual collaboration of shared objects.

2. Description of the Related Art

Real-time collaboration systems are useful for sharing information among multiple collaborators or participants, without requiring them to be physically co-located. Interpersonal communication involves a large number of subtle and complex visual cues, referred to by names like “eye contact” and “body language,” which provide additional information over and above the spoken words and explicit gestures. These cues are, for the most part, processed subconsciously by the participants, and often control the course of a meeting.

In addition to spoken words, demonstrative gestures and behavioral cues, collaboration often involves the sharing of visual information—e.g., printed material such as articles, drawings, photographs, charts and graphs, as well as videotapes and computer-based animations, visualizations and other displays—in such a way that the participants can collectively and interactively examine, discuss, annotate and revise the information. This combination of spoken words, gestures, visual cues and interactive data sharing significantly enhances the effectiveness of collaboration in a variety of contexts, such as “brainstorming” sessions among professionals in a particular field, consultations between one or more experts and one or more clients, sensitive business or political negotiations, and the like.

### BRIEF DESCRIPTION OF THE DRAWINGS

FIGS. 1A, 1B, and 1C illustrate an example layout for object collaboration.

FIG. 2 illustrates an example logic device.

FIGS. 3A, 3B, and 3C illustrate another example embodiment of a layout for object collaboration.

FIG. 4 illustrates a method of object collaboration.

FIGS. 5A, 5B, and 5C illustrate another example method of object collaboration.

### DESCRIPTION OF EXAMPLE EMBODIMENTS

### Overview

In one embodiment, an apparatus may have an interface system comprising at least one interface and a processor configured to: receive, via the interface system, a first video image captured by a first camera via a first polarized filter having a first polarization, the first video image pertaining to a first display at a first location; receive, via the interface system, a second video image from a first logic device, the second video image captured by a second camera via a second polarized filter having a second polarization, the second video image pertaining to a second display at a second location; transmit, via the interface system, the second video image to the first display; control the first display, via the interface system, to display the second video image, the first display having a third polarization substantially opposite from the first polarization; and transmit, via the interface system, the first video image to the first logic device, the first video image to be displayed onto the second display having a fourth polarization substantially opposite from the second polarization.

In another embodiment, a system may have a camera configured to receive a first video image via a polarized filter, an interface system comprising at least one interface, a logic device configured for communication with the camera via the interface system, the logic device configured to receive a first image and a second image via the interface system, the second image received from a remote location, and a display configured for communication with the logic device via the interface system, the display configured to display the second video image according to instructions from the logic device, wherein the second video image is displayed using polarized light emitted in a first plane and wherein the polarized filter comprises a filter oriented in a second plane substantially orthogonal to the first plane.

In another embodiment, a method may comprise receiving a first video image captured by a first camera via a first polarized filter, the first video image pertaining to a first display at a first location, receiving a second video image from a first logic device at a remote location, transmitting the second video image to the display device, controlling the display device to display the second video image, and transmitting the first video image to the first logic device, wherein the second video image is displayed on the display device using polarized light emitted in a first plane and wherein the first polarized filter comprises a filter oriented in a second plane substantially orthogonal to the first plane.

### Example Embodiments

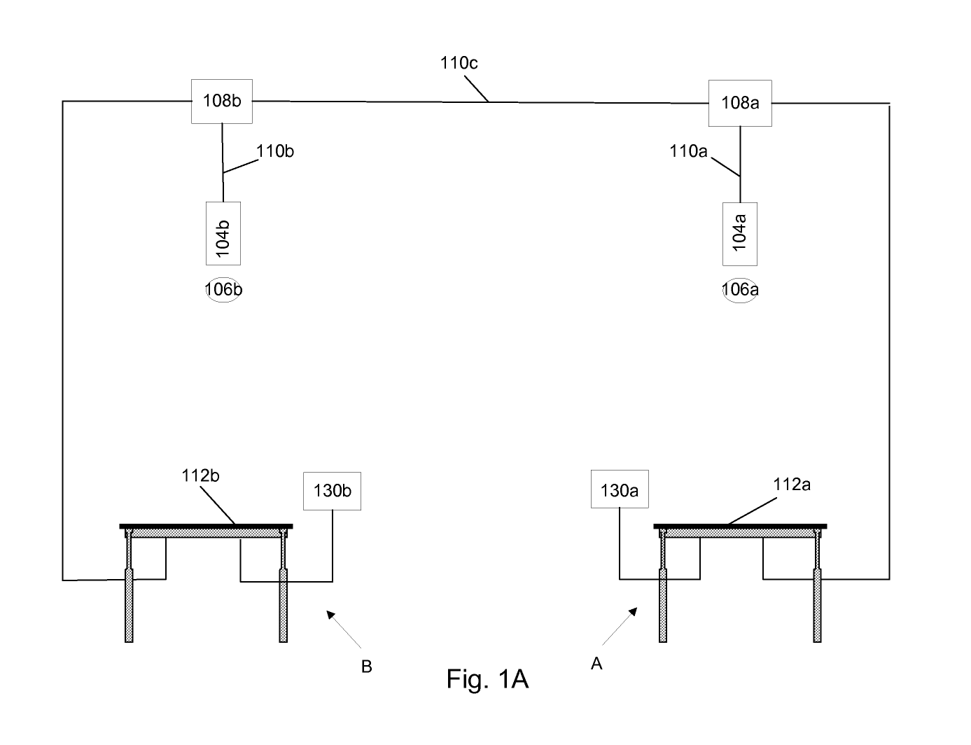

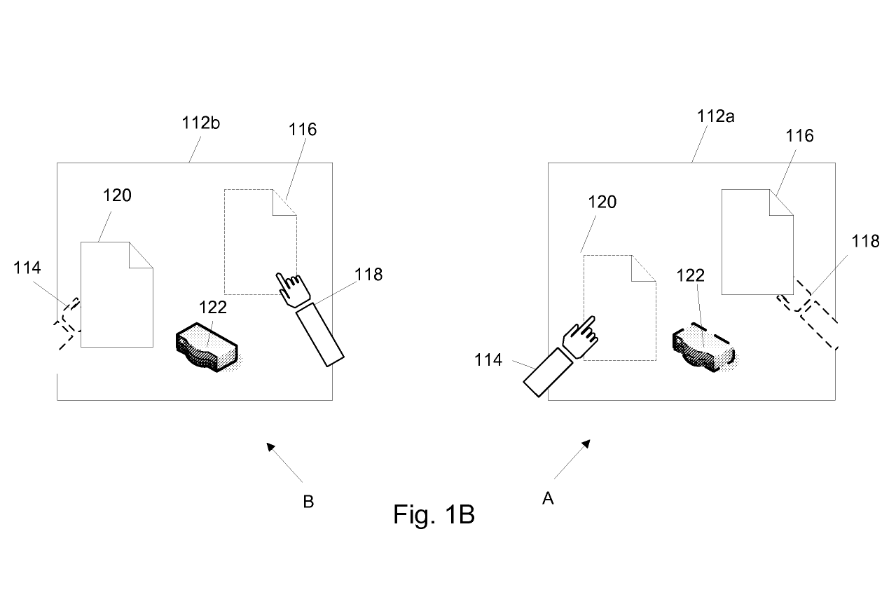

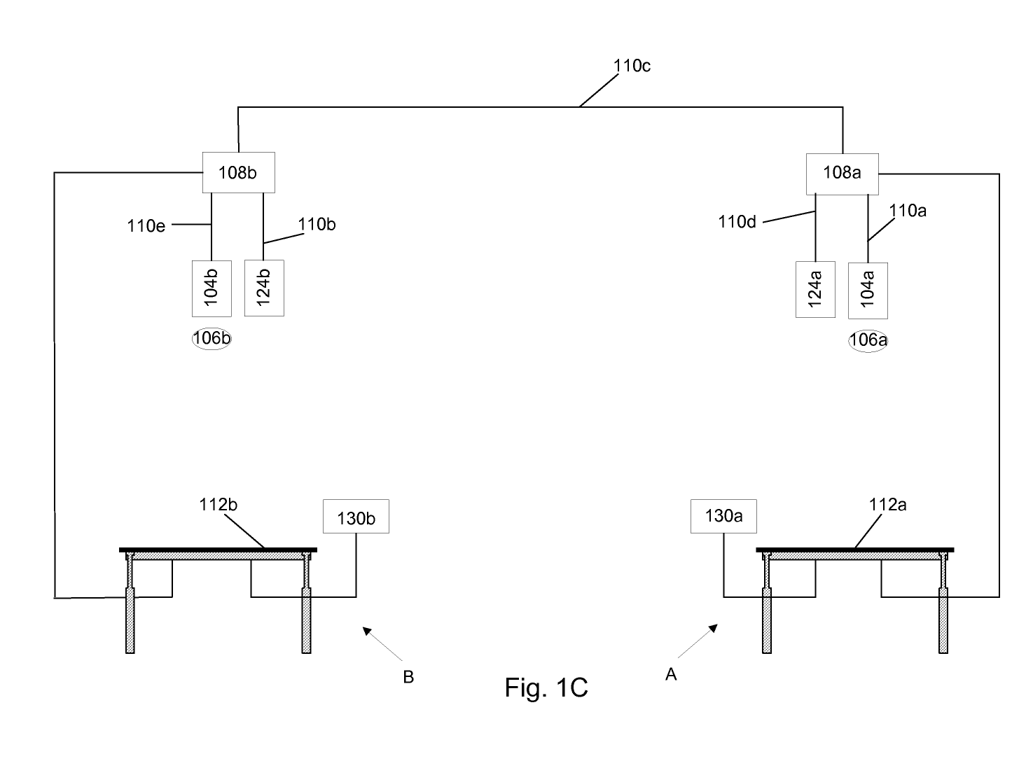

The present disclosure relates generally to the interactive collaboration of shared images on a display, such as a table or a screen. FIGS. 1A, 1B, and 1C illustrate an example layout for object collaboration. Referring to FIG. 1A, room A may be located at a different location than room B. The locations may be in different cities, different states, different floors of the same building, and the like. Room A may have a first camera 104a configured to receive or capture a first video image via a polarized lens or filter 106a and room B may have a second camera 104b configured to receive or capture a second video image via a polarized lens or filter 106b. In one embodiment, polarized filters 106a, 106b may have substantially the same polarization. In another embodiment, polarized filters 106a, 106b may have substantially different polarization angles. However, in either embodiment, the polarization angles of polarized filters 106a, 106b may be substantially different from the polarization of the emitted polarized light from the displays 112a, 112b as discussed further below.

The first video image may pertain to an image from the display 112a and the second video image may pertain to an image from the display 112b. The displays 112a, 112b may be controlled by logic devices 108a, 108b. The displays 112a, 112b may be a liquid crystal display (LCD) screen, or any other screen that projects polarized light to display the images. As further described below, the LCD display screen may be used to display objects for collaboration and/or users may write on the display to collaborate seamlessly and in real-time on the same objects such as Word™ documents, Power Point™ slides, or other computer images. The objects for collaboration may be obtained from a server, intranet, Internet, or any other known means via logic devices 108a, 108b.

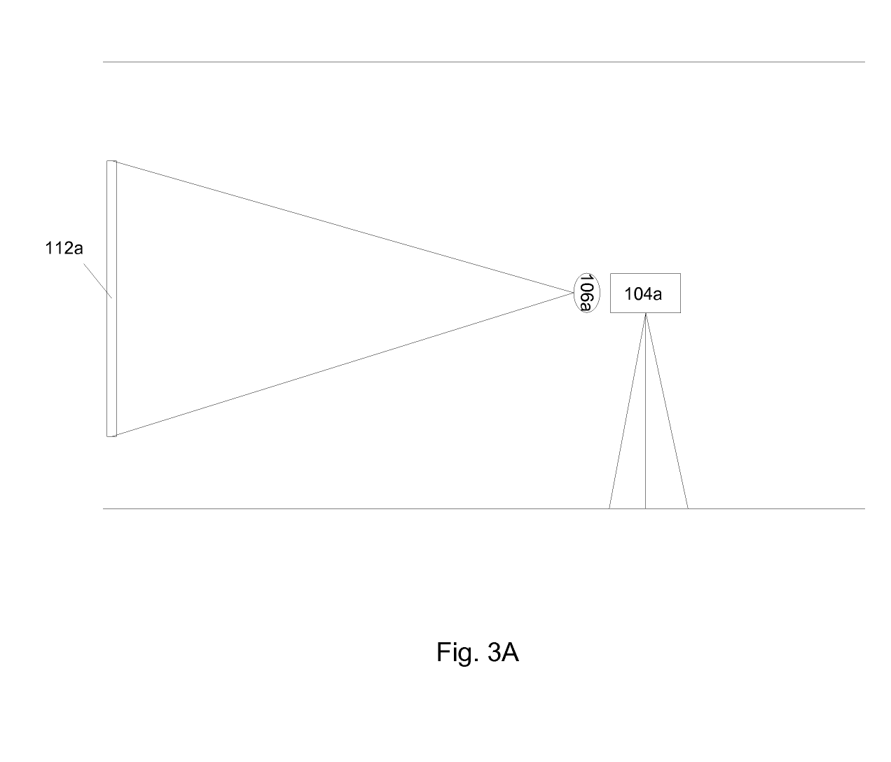

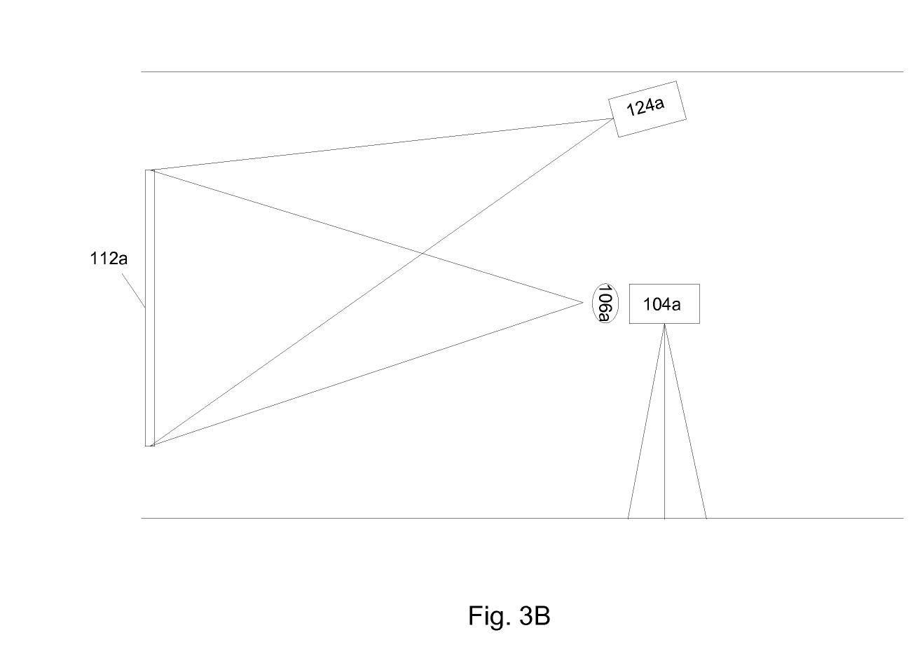

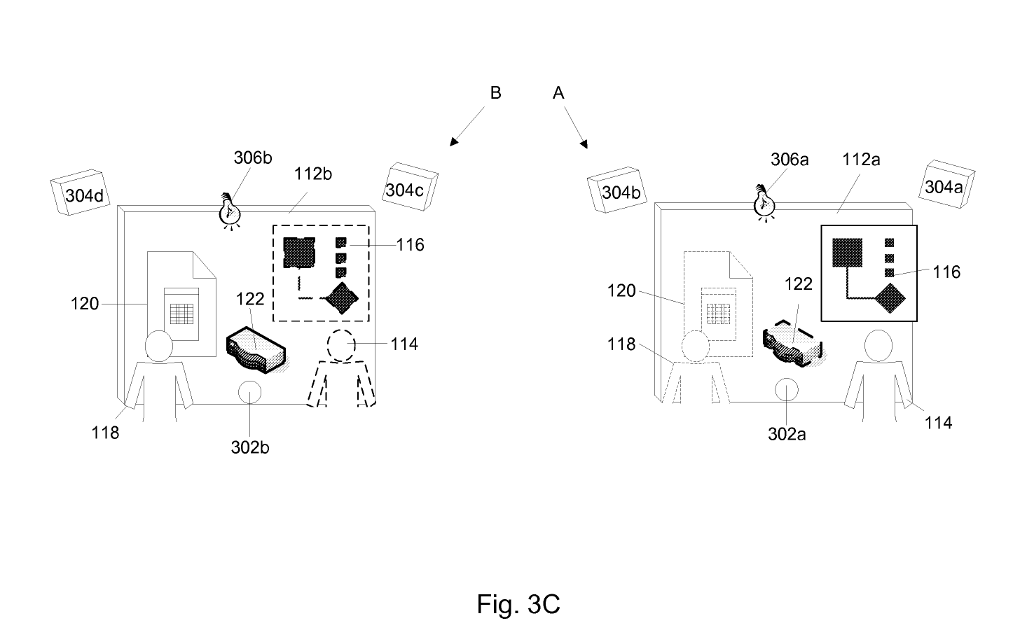

As illustrated in FIG. 1A, display 112a and display 112b may be positioned horizontally and used as a table or desktop. Cameras 104a, 104b may be positioned above displays 112a, 112b, respectively, to capture the respective images. In another embodiment, and as further discussed below, with reference to FIGS. 3A and 3B, displays 112a, 112b may be positioned vertically such as on a wall. Thus, cameras 104a, 104b may be positioned in front of the displays 112a, 112b, respectively.

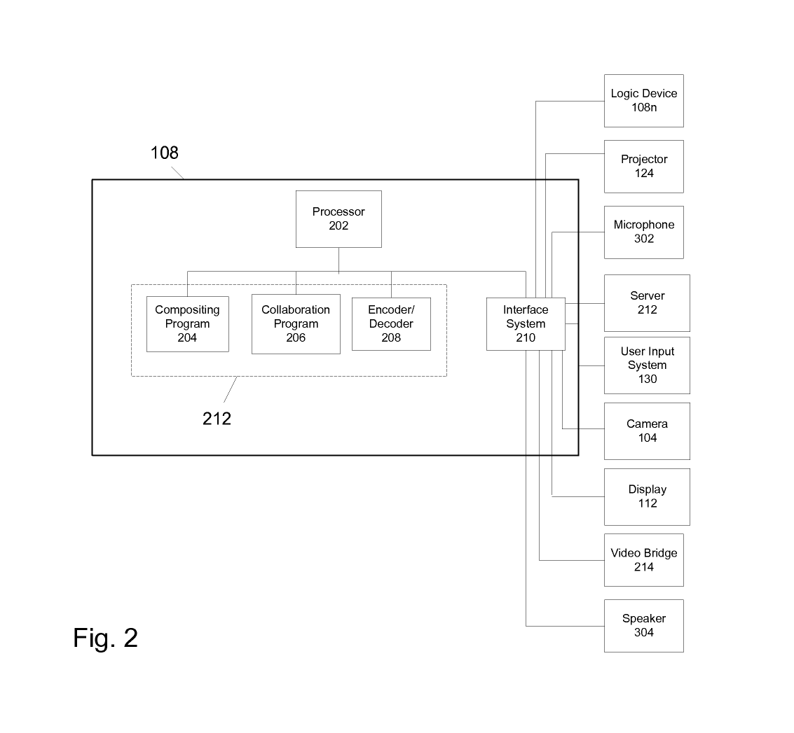

First camera 104a may be in communication with a logic device 108a via communication link 110a and second camera 104b may be in communication with logic device 108b via communication link 110b. Logic device 108a and logic device 108b may be in communication via communication link 110c. Communication links 110a, b, c may be any cable (eg., composite video cables, S-video cables), network bus, wireless link, internet, and the like. Logic device 108a, 108b may be any stand-alone device or networked device, such as a server, host device, and the like. Logic devices 108a, 108b, as further described in detail with reference to FIG. 2, may include a processor, encoder/decoder, collaboration program, or any other programmable logic devices or programs desired.

The polarization of polarized filter 106a may be substantially opposite or substantially equal in polarization from polarized filter 106b. In either embodiment, the polarization angles of polarized filters 106a, 106b may be opposite or orthogonal from the polarized light emitted from the displays 112a, 112b. For example, if the polarized light was emitted at about a 40°-50° angle, polarized filters 106a, 106b may be at approximately a 120°-160° angle. The oppositely polarized filters 106a, 106b filter out the polarized light thereby preventing feedback loops from occurring, i.e. the remote images projected onto the local display are not reflected or transmitted back to the originating location. Thus, the image that the cameras receive may not include the remote images projected onto the local display, just the local images.

Logic devices 108a, 108b may be configured to encode and decode the images. For example, first camera 104a may receive the first video image which is transmitted to and encoded by logic device 108a via communication link 110a. The first video image may be transmitted along communication link 110c to logic device 108b. Logic device 108b may decode the first video image and transmit the first video image to display 112b. Display 112b may be configured to display the first video image. Second camera 104b may receive the second video image from display 112b and may transmit the second video image to logic device 108b via communication link 110b. Logic device 108b may encode and transmit the second video image along communication link 110c to logic device 108a. Logic device 108a may decode and transmit the second video image to display 112a to display the second image.

Each camera is preferably calibrated to receive substantially the same images, i.e., the images should be substantially the same dimension, or the images may be off-centered. This ensures that the image at room B matches the image at room A. For example, if the first camera 104a was not calibrated, the image at room A would not match the image at room B. Thus, if User 114 (see, FIG. 1B) were to draw a figure, User 118 may not be able to see the entire figure or perhaps User 118 might not be able to add to or change the figure, thereby diminishing the interactive collaboration experience.

Additionally, the cameras and displays preferably have substantially the same aspect ratio. This also ensures that the images seen at the displays are substantially the same. For example, if the camera is a wide-screen camera, the display should also be a wide-screen display to allow the entire image to be viewed. Furthermore, displays 112a, 112b may have a writing surface disposed on the surface to allow a user to write on the displays 112a, 112b. The writing surface may be any type of glass surface or any other material suitable to be written on. Florescent or bright neon erasable markers may be used to write on the writing surface.

Referring to FIG. 1A and 1B, in use, User 114 may place a document 116 on display 112a and User 118 may place document 120 on the display 112b. First camera 104a receives the first video image which may be transmitted to and encoded by logic device 108a via communication link 110a. The first video image is then transmitted along communication link 110c to logic device 108b. Logic device 108b may decode the first video image and transmit the first video image to display 112b to display the first video image. The first video image may also include a portion of the hand of User 114. Since the originating object, document 120, would cover the virtual image portion of the hand of User 114, only a portion of the hand of User 114 may be visible on display 112b.

User 118 may place document 120 and draw a router 122 on display 112b. Second camera 104b may receive the second video image from display 112b and transmit the second video image to logic device 108b via communication link 110b. Logic device 108b may encode and transmit the second video image along communication link 110c to logic device 108a. Logic device 108a may decode and transmit the second video image to display 112a to display the second image. As discussed above, the original object, document 116, would cover the virtual image, thus only a portion of the hand of User 118 may be visible on display 112a.

In one embodiment, to collaborate on documents 116, 120, the first video image may be transmitted to the logic device 108a and the second video image may be transmitted to the logic device 108b. The logic devices 108a, 108b may be configured to operate a collaboration program to convert the video images to a digital image for collaboration. In another embodiment, logic devices 108a, 108b may be configured to receive the documents via any means such as wirelessly, intranet, Internet, or the like. Logic device 108a may transmit the second digital image, received from the logic device 108b, to display 112a. Logic device 108b may then transmit the first digital image, received from the logic device 108a, to display 112a. Once the digital images are displayed on displays 112a, 112b, users 114, 118 may add, amend, delete, and otherwise collaborate on the documents simultaneously using user input system 130a, 130b. Each user 114, 118 may be able to view each others' changes in real-time. The collaboration program may be any known collaboration program such as WebEX™ Meeting™ Center. The collaboration may occur over the internet, intranet, or through any other known collaboration means.

The display 112a may have a user input system 130a and display 112b may have a user input system 130b. The user input system 130a, 130b may allow Users 114, 118 to collaborate on the object to be collaborated upon by making changes, additions, and the like. User input system 130a, 130b may also be used to notify logic device 108a, 108b that the user 114, 118 would like to use the collaboration program to collaborate on objects. The user input system 130a, 130b may have at least one user input device to enable input from the user, such as a keyboard, mouse, touch screen display, and the like. In one embodiment, the touch screen display may be a touch screen overlay from NextWindow, Inc. of Auckland, New Zealand. The user input system 130a, 130b may be coupled to the display 112a, 112b via any known means such as a network interface, a USB port, wireless connection, and the like to receive input from the user.

In one embodiment, the digital collaboration program images may be combined with live camera video images using a composite program. The composite program may be contained in logic device 108a, 108b (illustrated in FIG. 2), obtained from a separate stand-alone device, received wirelessly, or any other means.

The composite program in logic device 108a may conduct real-time processing of compositing the first video image over the first digital image by compositing all non-black images received from the second camera 104b over the first digital image to generate a first composite image. Simultaneously, the composite program in logic device 108b may conduct real-time processing of compositing the second video image over the second digital image by compositing all non-black images received from the first camera 104a over the second digital image to generate a second composite image. The first composite image may be transmitted to the display 112a and the second composite image may be transmitted to the display 112b.

The composite program may be any known composite program such as a chroma key compositing program that removes the color (or small color range) from one image to reveal another image “behind” it. An example of a chroma key compositing program may be Composite Lab Pro™. In one example, the compositing program may make the digital collaboration image semi-opaque. This allows the video image from the opposite camera to be seen through the digital collaboration image. Thus, each user 114, 118 may view the other in real-time while collaborating on objects digitally displayed on their respective remote displays 112a, 112b.

FIG. 1C illustrates another embodiment of a layout for the collaboration. FIG. 1C is similar to FIG. 1A but includes a projector 124a and a projector 124b to allow for the simultaneous display of a live video feed and digital image for document collaboration. Projector 124a may be in communication with logic device 108a via communication link 110e and projector 124b may be in communication with logic device 108b via communication link 110e.

The cameras 104a, 104b may be positioned substantially near the projectors 124a, 124b. The cameras 104a, 104b may be positioned below the projectors 124a, 124b (as illustrated in FIG. 3b), positioned above the projectors 124a, 124b, or co-located with the projectors 124a, 124b. The cameras and projectors may be calibrated to view and receive substantially the same images, i.e., the images may be substantially the same dimension, or the images may be off-centered. This ensures that the image at room B substantially matches the image at room A.

In use, projector 124a is configured to project the decoded second video image received from logic device 108a onto display 112a according to instructions from logic device 108a. Projector 124b is configured to project the decoded first video image received from logic device 108b onto display 112b according to instructions from logic device 108b. Thus, while Users 114, 118 are collaborating on an object on their respective displays, they may simultaneously receive remote video images from each others' locations that are projected onto the displays.

For example, at room A, the hand of User 114 may be viewed in person, but only a virtual image of the hand of User 114 is projected by projector 124b onto the display 112b. Conversely, at room B, the hand of User 118 is viewed in person, but a virtual image of the hand of User 118 is projected by projector 124a onto display 112a. User 114, 118 are able to simultaneously and seamlessly interact, view objects placed on the displays and/or see each other write on the displays 112a, 112b. They are able to collaborate and add to common diagrams and/or designs, fill in blanks or notes, complete each other's notes, figures, or equations, and the like. Additionally, this may occur simultaneously as documents such as projection slides, documents, and other digital images may be displayed to allow for the co-presentation and/or collaboration of materials.

Projectors 124a, 124b may emit polarized light when projecting the video images. The polarized light may be received by cameras 104a, 104b. However, oppositely polarized filters 106a, 106b may filter out the polarized light thereby preventing feedback loops from occurring, i.e. the remote images projected onto the local presentation screen are not reflected or transmitted back to the originating location. Thus, the image that the cameras transmit to the projectors does not include the remote images projected onto the local presentation screen, just the local images. In one embodiment, polarized filter 106a may have substantially the same polarization as polarized filter 106b. In another embodiment, polarized filter 106a may have substantially the opposite polarization from polarized filter 106b.

FIG. 2 illustrates an example logic device. Although illustrated with specific programs and devices, it is not intended to be limiting as any other programs and devices may be used as desired. Logic device 108 may have a processor 202 and a memory 212. Memory 212 may be any type of memory such as a random access memory (RAM). Memory 212 may store any type of programs such as a collaboration program 206, compositing program 204, and encoder/decoder 208. As discussed above, collaboration program 206 may be used to allow users to collaborate on objects, such as documents. Compositing program 204 may be used to allow users to collaborate on documents in addition to viewing each other in real-time. The logic device 108 may have an encoder/decoder 208 to encode and/or decode the signals for transmission along the communication link.

An interface system 210, having a plurality of input/output interfaces, may be used to interface a plurality of devices with the logic device 108. For example, interface system 210 may be configured for communication with a camera 104, projector 124, speaker 304, microphone 302, other logic devices 108n (where n is an integer), server 212, video bridge 214, display 112, and the like. These and other devices may be interfaced with the logic device 108 through any known interfaces such as a parallel port, game port, video interface, a universal serial bus (USB), wireless interface, or the like. The type of interface is not intended to be limiting as any combination of hardware and software needed to allow the various input/output devices to communicate with the logic device 108 may be used.

A user input system 130 may also be coupled to the interface system 210 to receive input from the user. The user input system 130 may be any device to enable input from a user such as a keyboard, mouse, touch screen display, track ball, joystick, or the like.

FIGS. 3A, 3B, and 3C illustrate another example embodiment of a layout for object collaboration. FIG. 3A is a side view of the collaboration layout of one embodiment. Camera 104a may be positioned substantially centered to the display 112a. FIG. 3B illustrates the use of a projector 124a positioned in front of display 112a to project a video image onto the display 112a in the same manner as discussed above with reference to FIG. 1C. Display 112a may be positioned vertically, such as on a wall. Camera 104a may be positioned in front of display 112a to capture the image on display 112a.

As illustrated in FIG. 3C, images of each user may also be captured and displayed. Each user 114, 118 may be proximate to the display 112a, 112b, respectively. First camera 104a may receive the first video image of User 114 and any writings, drawings, and the like from display 112a. The first video image may be transmitted to and encoded by logic device 108a. The first video image and/or first digital image may be, transmitted along communication link 110c, and decoded by logic device 108b. The first video image may be transmitted to projector 124b for projection on the display 112b and the first digital image, if any, may be transmitted to the display 112b to be displayed.

Simultaneously, second camera 104b (See, FIG. 1A) may receive a second video image of User 118 and any writings, drawings, and the like. The second video image may be transmitted and encoded by logic device 108b. The second video image and/or second digital image may be transmitted along communication link 110c, and decoded by logic device 108a. The second video image may then be transmitted to projector 124a for projection on the display 112b and the second digital image may be transmitted to the display 112a to be displayed.

At room A, User 114 may be viewed in person, but only a virtual image of remote User 114 is displayed on display 112b. Conversely, at room B, User 118 may be viewed in person, but a virtual image of remote User 118 is displayed on display 112a. Both User and B are able to simultaneously and seamlessly interact on the display and see each other write on the displays 112a, 112b. They are able to collaborate and add to common diagrams and/or designs, fill in blanks or notes, complete each other's notes, figures, or equations, and the like. A collaboration program such as MeetingPlace™ Whiteboard collaboration may be used. Additionally, digital images may also be displayed to allow for the co-presentation of materials.

An additional black or fluorescent light source 306a, 306b may be used with each display 112a, 112b to illuminate the images on the display 112a, 112b. The light source 306a, 306b may be used to highlight the florescent colors from a florescent erasable marker when the User 114, 118 writes on the display 112a, 112b. When positioned at an angle, the light source may provide additional light to illuminate the display 112a, 112b to allow the user to better view the images on the display.

Microphones and speakers may be used at each location to provide for audio conferencing. The microphones and speakers may be built into display 112a, 112b. In another embodiment, as illustrated in FIG. 3C, microphones 302a, 302b and speakers 304a, 304b, 304c, 304d may be external and separate from the displays 112a, 112b. In use, microphone 302a may receive a first audio signal that may be transmitted to logic device 108a. Logic device 108a encodes the first audio signal and transmits the first audio signal to logic device 108b along communication link 110c. Logic device 108b decodes the first audio signal for transmission at speakers 304c,d. Simultaneously, microphone 302b may receive a second audio signal that may be transmitted to logic device 108b. Logic device 108b may encode the second audio signal and transmit the second audio signal to logic device 108a along communication link 110c. Logic device 108a decodes the second audio signal for transmission at speakers 304a,b. Although illustrated with one microphone and two speakers at each location, the number is not intended to be limiting as any number of microphones and speakers may be used.

Although illustrated with the use of two remote locations, the number of remote locations is not intended to be limiting as any number of remote locations may be used to provide for multi-point video conferencing. Users may participate and collaborate in a multi-point conference environment with multiple remote locations. Video images from multiple rooms maybe received and combined with a video bridge (not shown). The video bridge 108 may be any video compositing/combining device such as the Cisco IP/VC3511 made by Cisco Systems, Inc. of San Jose, Calif. The video bridge may combine all the images into one combined image and transmit the combined image back to each logic device for display on the displays at the remote locations.

Thus, multiple presenters may present, participate, and collaborate simultaneously, each able to virtually see what other writes and says. The multiple presenters may collaborate in a seamless, real-time, and concurrent collaboration environment.

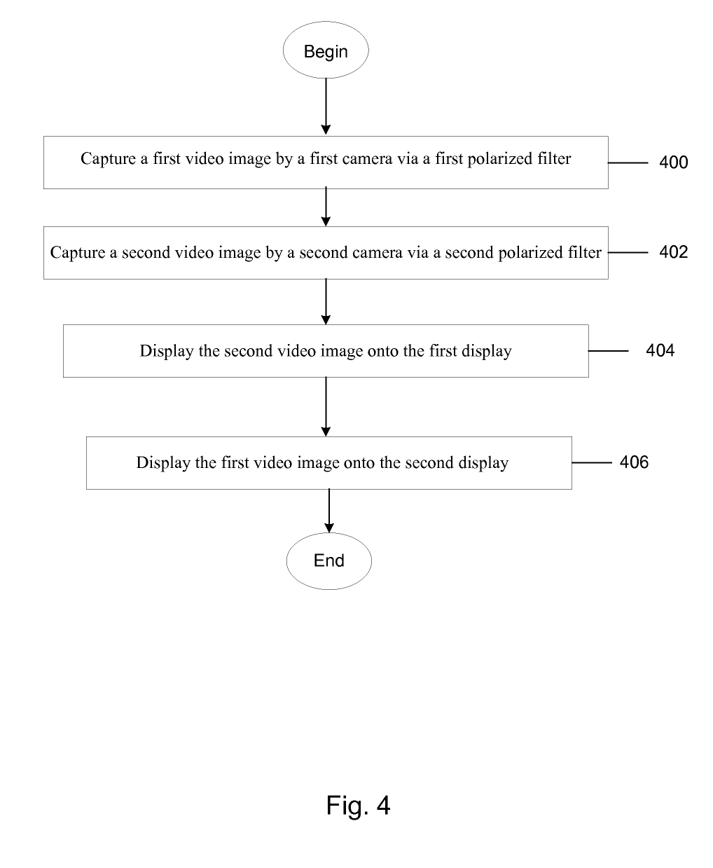

FIG. 4 illustrates a method of object collaboration. A first video image may be captured by a first camera via a first polarized filter at 400. The first video image may be captured at a first location. A second video image may be captured by a second camera via a second polarized filter at 402. The second video image may be captured at a second location remote from the first location. The locations may be in different cities, different states, different floors of the same building, and the like. The second video image may be transmitted and displayed on the first display at 404 via a communication link. The first video image may be transmitted and displayed on the second display at 406 via the communication link.

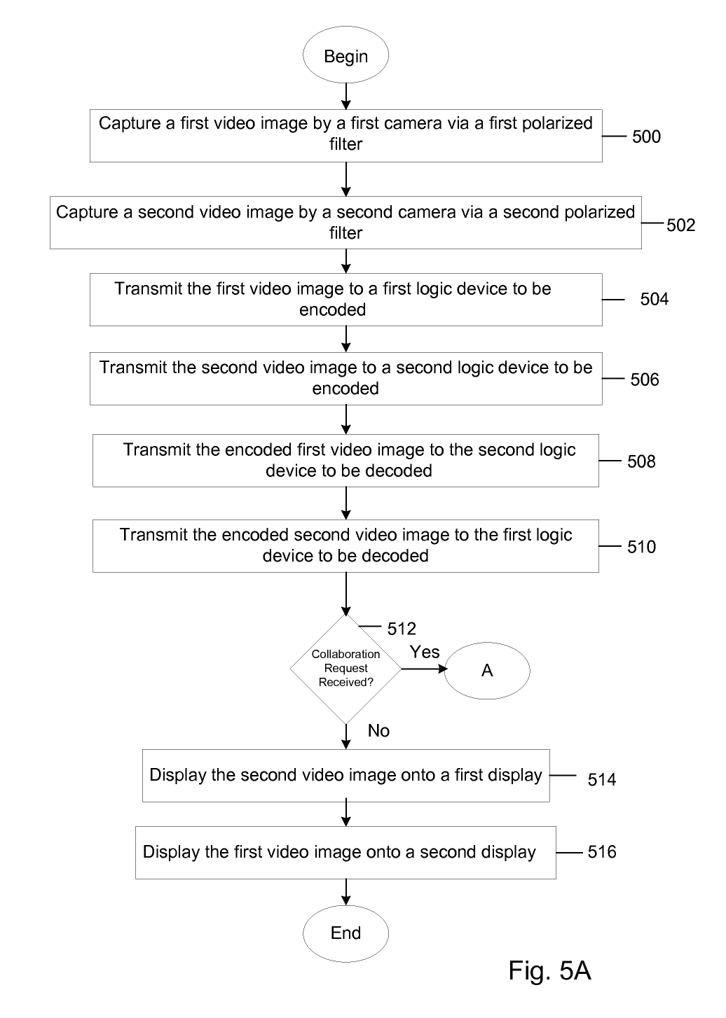

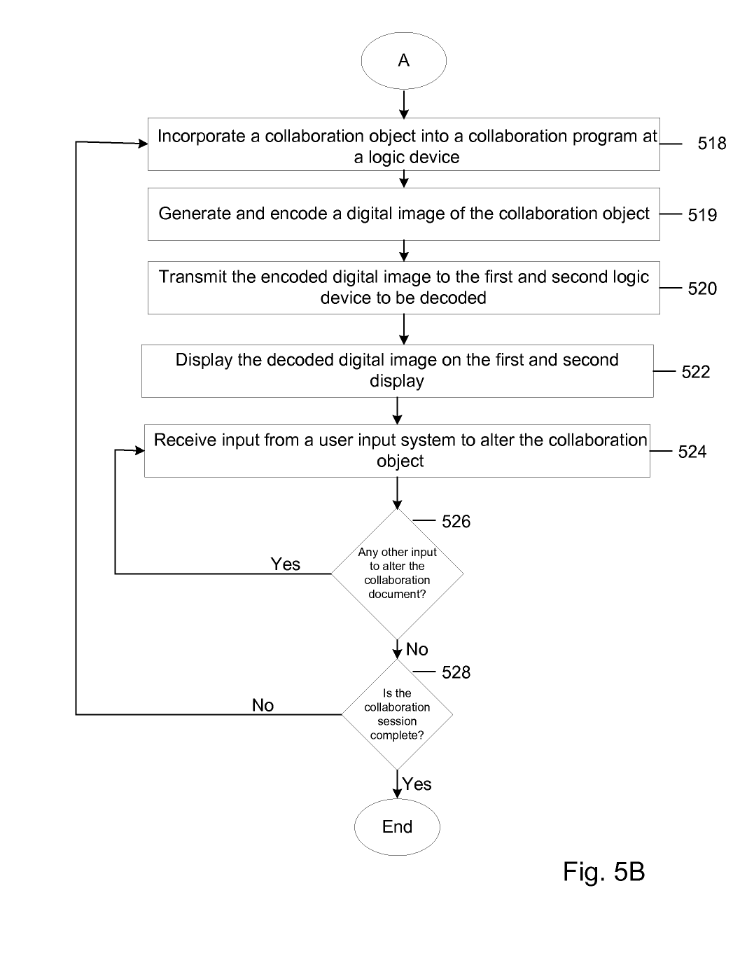

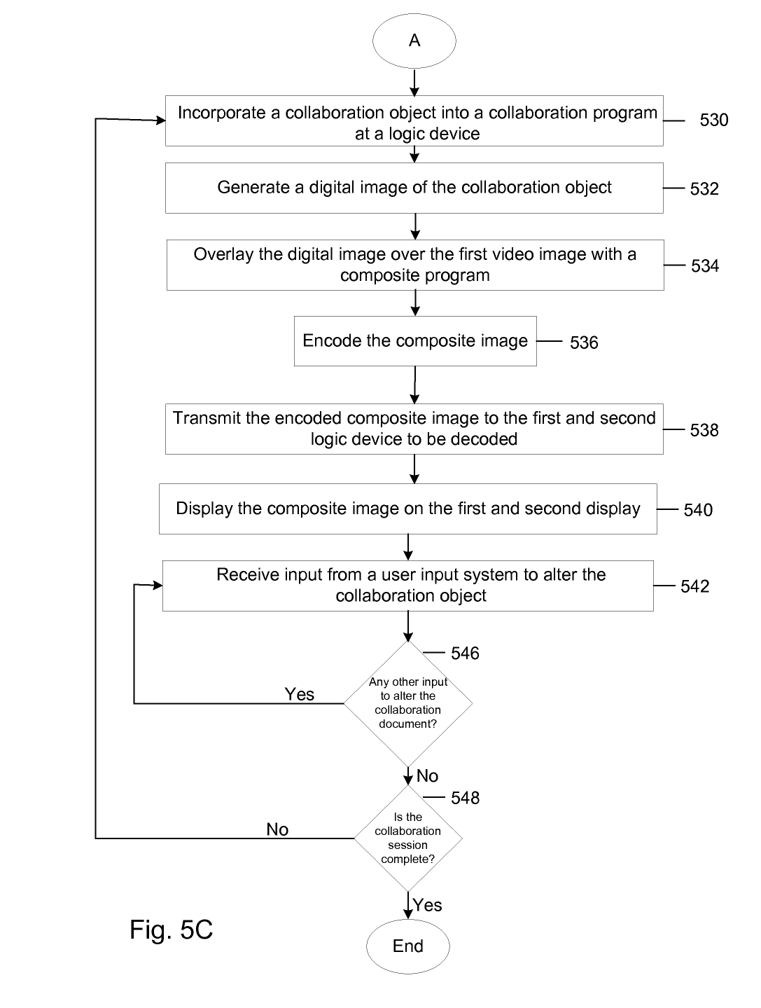

FIGS. 5A and 5B illustrate another example method of object collaboration. A first video image may be captured by a first camera via a first polarized filter at 500. The first video image may be captured at a first location. A second video image may be captured by a second camera via a second polarized filter at 502. The second video image may be captured at a second location remote from the first location. The first video image may be transmitted to a first logic device to be encoded at 504. The second video image may be transmitted to a second logic device to be encoded at 506. The first logic device and second logic device may be in communicatively coupled to each other via a communication link such that the encoded first video image may be transmitted to the second logic device to be decoded at 508 and the second video image may be transmitted to the first logic device to be decoded at 510.

Should the users desire to collaborate on an object and want to use a collaboration program, a request may be made at 512. The object may be any document such as a Word™ or Power Point™ document, Excel™ spreadsheet, and the like. Should the users not desire to collaborate on a document, the second video image may be displayed on the first display at 514 and the first video image may be displayed on the second display at 516.

Referring now to FIG. 5B, should the users request to collaborate on an object at 512, the object may be incorporated into a collaboration program by a logic device at 518. In one embodiment, a digital image of the object may be generated and transmitted to the first logic device where it is encoded at 519 and transmitted to a second logic device to be incorporated into a collaboration program as discussed above. In another embodiment, the object may be incorporated into a collaboration program at 518 by the first logic device, a digital image may be generated and encoded at 519, and then transmitted to the second logic device. Thus, the collaboration program at the first logic device or the second logic device may be used.

Once incorporated into the collaboration program and encoded, the digital signal may be transmitted to the other logic device at 520 to be displayed on the respective displays at 522. Each user may then collaborate and/or alter on the document using a user input system at 524. If there are no more inputs received from the users at 526 but the collaboration session is not over at 528, the steps are repeated at 518.

FIG. 5C illustrates yet another example of object collaboration utilizing both the collaboration program and composite program of the logic devices. Although described with reference to use of the first logic device, use of the first logic device is not intended to be limiting as the programs in the any of the logic devices may be used for the collaboration and compositing of the objects and images. Should the users request to collaborate on an object at 512 in FIG. 5A, the object may be incorporated into a collaboration program at a logic device at 530. As stated above, the collaboration program of the first logic device or the second logic device may be used. A digital image of the collaboration object may be generated at 532. The digital image may be overlaid over the first video image with a composite program at 534 on the first logic device. The composite image may then be encoded at 536 and transmitted to the first and second logic devices to be decoded at 538. The composite image may then be displayed on the first and second display at 540.

The user may collaborate on the collaboration object by using any user input system to alter the object at 542. If there are no other inputs to alter the document received at 546 but the collaboration session is not complete at 548, the steps are repeated from 530.

Although illustrative embodiments and applications of this invention are shown and described herein, many variations and modifications are possible which remain within the concept, scope, and spirit of the invention, and these variations would become clear to those of ordinary skill in the art after perusal of this application. Accordingly, the embodiments described are to be considered as illustrative and not restrictive, and the invention is not to be limited to the details given herein, but may be modified within the scope and equivalents of the appended claims.

1. A logic device, comprising:
an interface system comprising at least one interface;
a processor configured to:
receive, via the interface system, a first video image captured by a first camera via a first polarized filter having a first polarization, the first video image pertaining to a first display at a first location;
receive, via the interface system, a second video image from a first logic device, the second video image captured by a second camera via a second polarized filter having a second polarization, the second video image pertaining to a second display at a second location;
transmit, via the interface system, the second video image to the first display;
control the first display, via the interface system, to display the second video image, the first display having a third polarization substantially opposite from the first polarization; and
transmit, via the interface system, the first video image to the first logic device, the first video image to be displayed onto the second display having a fourth polarization substantially opposite from the second polarization.

2. The logic device of claim 1, wherein the interface system comprises a user input interface for receiving input from a user input system.

3. The logic device of claim 1, wherein the processor is further configured to control the display device to generate a first digital image, wherein the first digital image corresponds to a collaboration document received from the first logic device.

4. The logic device of claim 3, wherein the processor is further configured to control a display device to overlay the first video image over the first digital image.

5. The logic device of claim 1, further comprising a video bridge interface configured to receive video images from a plurality of other logic devices.

6. A system, comprising:
a camera configured to receive a first video image via a polarized filter;
an interface system comprising at least one interface;
a logic device configured for communication with the camera via the interface system, the logic device configured to receive a first image and a second image via the interface system, the second image received from a remote location; and
an imaging device configured for communication with the logic device via the interface system, the imaging device configured to display the second video image according to instructions from the logic device,
wherein the second video image is displayed using polarized light emitted in a first plane and wherein the polarized filter comprises a filter oriented in a second plane substantially orthogonal to the first plane.

7. The system of claim 6, further comprising a user input system configured for communication with the display.

8. The system of claim 6, wherein the logic device is configured to execute a collaboration program and control the display to generate a digital image, wherein the digital image corresponds to a collaboration document.

9. The system of claim 6, wherein the logic device is configured to:
execute a collaboration program to generate a digital image;
execute a compositing program; and
overlay the first video image over the digital image using the compositing program.

10. The system of claim 6, wherein the imaging device is a display or a projector.

11. A method, comprising:
receiving a first video image captured by a first camera via a first polarized filter, the first video image pertaining to a first display at a first location;
receiving a second video image from a first logic device at a remote location;
transmitting the second video image to the display device;
controlling the display device to display the second video image; and
transmitting the first video image to the first logic device,
wherein the second video image is displayed on the display device using polarized light emitted in a first plane and wherein the first polarized filter comprises a filter oriented in a second plane substantially orthogonal to the first plane.

12. The method of claim 11, further comprising:
converting the first video image to a first digital image with a collaboration program; and
transmitting the first digital image to the first logic device.

13. The method of claim 11, further comprising:
converting the second video image to a second digital image with a collaboration program;
transmitting the second digital image to the display device.

14. The method of claim 12, further comprising overlaying the first video image over the first digital image using a compositing program to form a first composite image.

15. The method of claim 13, further comprising overlaying the second video image over the second digital image using a compositing program to form a second composite image.

16. An apparatus, comprising:
means for receiving a first video image captured by a first camera via a first polarized filter, the first video image pertaining to a first display at a first location;
means for receiving a second video image from a first logic device at a remote location;
means for transmitting the second video image to the display device;
means for controlling the display device to display the second video image; and
means for transmitting the first video image to the first logic device,
wherein the second video image is displayed on the display device using polarized light emitted in a first plane and wherein the first polarized filter comprises a filter oriented in a second plane substantially orthogonal to the first plane.

17. The apparatus of claim 16, further comprising:
means for converting the first video image to a first digital image with a collaboration program; and
means for transmitting the first digital image to the first logic device.

18. The apparatus of claim 16, further comprising:
means for converting the second video image to a second digital image with a collaboration program;
means for transmitting the second digital image to the display device.

19. The apparatus of claim 17, further comprising means for overlaying the first video image over the first digital image using a compositing program to form a first composite image.

20. The apparatus of claim 18, further comprising means for overlaying the second video image over the second digital image using a compositing program to form a second composite image.
